(19) United States
(12) Patent Application Publication
(10) Pub. No.: US 2009/0285924 A1
(43) Pub. Date: Nov. 19, 2009

(54) JIG FOR EXTRUSION-FORMING

(75) Inventor: Makoto MURAI, Nagoya-city (JP)

Correspondence Address: OLIFF & BERRIDGE, PLC, P.O. BOX 320850, ALEXANDRIA, VA, 22320-4850, US

(73) Assignee: NGK INSULATORS, LTD., Nagoya-city (JP)

(21) Appl. No.: 12/510,773

(22) Filed: Jul. 28, 2009

Related U.S. Application Data
(63) Continuation of application No. PCT/JP2008/050845, filed on Jan. 23, 2008.

(30) Foreign Application Priority Data
Feb. 1, 2007 (JP) 2007-023565

(51) Int. Cl. B29C 47/30

(52) U.S. Cl. 425/199

(57) ABSTRACT

A jig for extrusion-forming is to be used to obtain a formed ceramic article by extrusion-forming. The jig for extrusion-forming includes a cylindrical extrusion passage into which kneaded clay is fed; a filtering mesh which is arranged to cover an inlet of the extrusion passage and which removes coarse particles and foreign matter from the clay; a first porous plate brought into contact with the filtering mesh and provided with a plurality of through-holes; a second porous plate arranged to leave a space from the first porous plate in the extrusion passage and provided with a plurality of through-holes; and a die arranged to leave a space from the second porous plate in the extrusion passage, and the arrangement of the through-holes of the first porous plate does not coincide with the arrangement of the through-holes of the second porous plate in the extruding direction of the clay.

### TECHNICAL FIELD

The present invention relates to a jig for extrusion-forming which is used to obtain a formed ceramic article by extrusion. Particularly, the present invention can preferably be applied to the extrusion-forming of a formed ceramic honeycomb article having a thin wall structure.

### BACKGROUND ART

A honeycomb-like structure (a honeycomb structure) is broadly used as a carrier for a purification catalyst of an exhaust gas from any type of internal combustion engine typified by a car exhaust gas, a deodorizing catalyst carrier, a filter for any type of filtering device, a heat exchanger unit, or a chemical reaction device carrier such as a reforming catalyst carrier of a fuel cell. Such a honeycomb structure is usually manufactured by extrusion-forming kneaded clay of a ceramic raw material or the like to obtain a formed article (a formed ceramic honeycomb article) having a predetermined honeycomb structure, and drying and firing this article.

Heretofore, it has been general to use a jig for extrusion-forming having a structure shown in FIG. 4 so that the clay is extrusion-formed to obtain the formed ceramic honeycomb article. This jig for extrusion-forming includes a cylindrical extrusion passage 1 into which the kneaded clay is fed; a filtering mesh 2 which is arranged so as to cover an inlet of the extrusion passage 1 and which removes coarse particles and foreign matter from the kneaded clay; a porous plate 9 brought into contact with the filtering mesh 2 and provided with a plurality of through-holes 10; and a die 5 arranged so as to leave a space from the porous plate 9 in the extrusion passage 1. The porous plate 10 is used as a support member which backs up the filtering mesh 2 lest the thin filtering mesh 2 having low strength should break under pressure when the clay passes. The die 5 is provided with slits formed in accordance with the dimensions of through-holes and partition walls of the formed ceramic honeycomb article to be obtained (e.g., see Patent Documents 1 and 2).

The clay fed from the inlet of the extrusion passage 1 into the extrusion passage 1 first passes through the filtering mesh 2, and the coarse particles and foreign matter having particle diameters larger than predetermined particle diameters are removed (filtered) from the clay at this time. The clay which has passed through the filtering mesh 2 then passes through the through-holes 10 of the porous plate 9 and is extruded into a noodle-like shape in the space between the porous plate 9 and the die 5. The thus extruded clay is pushed from one end face of the die 5 to the slits formed in die and is formed and extruded into a honeycomb-like shape from the other end face of the die 5.

However, in a case where the formed ceramic honeycomb article is formed using the above conventional jig for extrusion-forming, the coarse particles and foreign matter which cannot pass through the filtering mesh 2 in the kneaded clay remain on the filtering mesh 2 to clog a part of meshes. Therefore, the subsequent clay cannot flow into the extrusion passage 1 from the clogged part, and eventually partial deviation is generated in the amount of the clay fed into the die 5. The resultant formed article is deformed, and high yield is not easily obtained. Moreover, the clogged filtering mesh 2 has to be frequently changed, which causes a problem of low productivity.

Patent Document 1: JP-A-8-62721

Patent Document 2: JP-A-2002-26909

### DISCLOSURE OF THE INVENTION

The present invention has been developed in view of such a conventional situation, and an object thereof is to provide a jig for extrusion-forming in which partial deviation is not easily generated in the amount of clay to be fed into a die and in which high yield and productivity can be obtained even in a case where a part of a filtering mesh is clogged with coarse particles and foreign matter contained in kneaded clay during extrusion-forming into a formed ceramic article such as a formed ceramic honeycomb article.

To achieve the above object, according to the present invention, the following jig for extrusion-forming is provided.

[1] A jig for extrusion-forming which is to be used to obtain a formed ceramic article by extrusion-forming, comprising: a cylindrical extrusion passage into which clay is fed; a filtering mesh which is arranged so as to cover an inlet of the extrusion passage and which removes coarse particles and foreign matter from the clay; a first porous plate brought into contact with the filtering mesh and provided with a plurality of through-holes; a second porous plate arranged so as to leave a space from the first porous plate in the extrusion passage and provided with a plurality of through-holes; and a die is arranged so as to leave a space from the second porous plate in the extrusion passage, wherein the arrangement of the through-holes of the first porous plate does not coincide with the arrangement of the through-holes of the second porous plate in the extruding direction of the clay.

[2] The jig for extrusion-forming according to [1], wherein the formed ceramic article is a formed ceramic honeycomb article having a honeycomb structure.

In a case where the formed ceramic article is obtained by extrusion-forming using the jig for extrusion-forming of the present invention, even in a state in which a part of the filtering mesh is clogged with the coarse particles and foreign matter contained in the clay, partial deviation is not easily generated in the amount of the clay to be fed into the die, and high yield and productivity can be obtained.

### BRIEF DESCRIPTION OF THE DRAWINGS

FIG. 1 is a schematic sectional view showing one example of the structure of a jig for extrusion-forming according to the present invention.

FIG. 2 is an explanatory view showing one example of an arrangement relation between through-holes in the first porous plate and through-holes in the second porous plate.

FIG. 3 is an explanatory view showing another example of the arrangement relation between the through-holes in the first porous plate and the through-holes in the second porous plate.

FIG. 4 is a schematic sectional view showing the structure of a conventional jig for extrusion-forming.

### DESCRIPTION OF REFERENCE NUMERALS

1: extrusion passage, 2: filtering mesh, 3: first porous plate, 4: second porous plate, 5: die, 6: through-holes, 7: through-holes, 8: space, 9: porous plate, 10: through-holes.

### BEST MODE FOR CARRYING OUT THE INVENTION

A representative embodiment of the present invention will hereinafter specifically be described with reference to the drawings. It should be understood that the present invention is not limited to the following embodiment and that design may appropriately be changed or modified based on the ordinary knowledge of any person skilled in the art without deviating from the gist of the present invention.

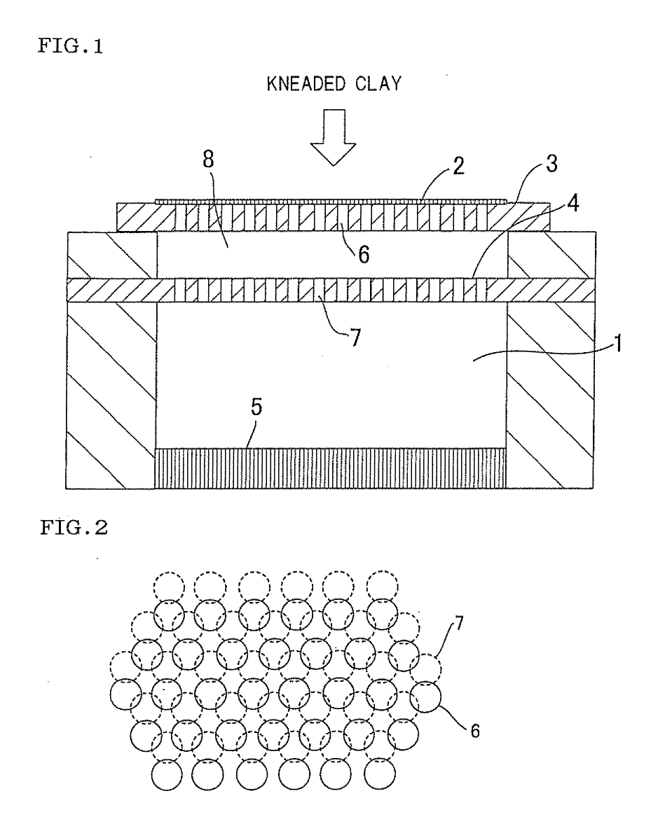

FIG. 1 is a schematic sectional view showing one example of the structure of a jig for extrusion-forming according to the present invention. This jig for extrusion-forming includes a cylindrical extrusion passage 1 into which a clay is fed; a filtering mesh 2 which is arranged so as to cover an inlet of the extrusion passage 1 and which removes coarse particles and foreign matter from the clay; a first porous plate 3 brought into contact with the filtering mesh 2 and provided with a plurality of through-holes 6; a second porous plate 4 arranged so as to leave a space from the first porous plate 3 in the extrusion passage 1 and provided with a plurality of through-holes 7; and a die 5 arranged so as to leave a space from the second porous plate 4 in the extrusion passage 1. The first porous plate 3 is used as a support member which backs up the filtering mesh 2 lest the thin filtering mesh 2 having low strength should break under pressure when the clay passes. In the jig for extrusion-forming according to the present embodiment, a formed ceramic article as a forming target is a formed ceramic honeycomb article having a honeycomb structure, and the die 5 is provided with slits in accordance with the dimensions of the through-holes and partition walls of the formed ceramic honeycomb article to be obtained.

When the formed ceramic honeycomb article is obtained by extrusion-forming using this jig for extrusion-forming, the kneaded clay fed from the inlet of the extrusion passage 1 into the extrusion passage I first passes through the filtering mesh 2, and coarse particles and foreign matter having particle diameters larger than predetermined particle diameters are removed (filtered) from the kneaded clay at this time. The kneaded clay which has passed through the filtering mesh 2 then passes through the through-holes 6 of the first porous plate 3 arranged so that the plate comes in contact with the filtering mesh 2, and the clay is extruded into a noodle-like shape in a space 8 between the first porous plate 3 and the second porous plate 4.

Here, in a case where the coarse particles and foreign matter which cannot pass through the filtering mesh 2 in the kneaded clay remain on the filtering mesh 2 to close a part of meshes, the subsequent kneaded clay cannot flow from the closed part into the through-holes 6 disposed immediately under the part, and eventually partial deviation is generated in the amount of the clay to be extruded from the through-holes 6 in a stage in which the clay passes through the first porous plate 3.

However, in the jig for extrusion-forming according to the present invention, the clay which has passed through the through-holes 6 of the first porous plate 3 is not fed into the die 5 as it is. The clay once enters the space 8 between the first porous plate 3 and the second porous plate 4, and the space 8 is substantially filled with the clay. Afterward, the clay passes through the through-holes 7 of the second porous plate 4 and is fed into the die 5. That is, even the space downstream the through-holes 6 of the first porous plate 3, into which the kneaded clay cannot flow owing to the partially clogged filtering mesh 2, is filled with the clay which has entered the space through the other through-holes 6. Afterward, the clay is evenly extruded from the through-holes 7 of the second porous plate 4. The thus extruded clay is pushed from one end face of the die 5 to the slits formed in the die 5, and is formed and extruded into a honeycomb shape from the other end face of the die 5, thereby forming the formed ceramic honeycomb article.

Thus, in the jig for extrusion-forming according to the present invention, the second porous plate 4 is arranged with the space from the first porous plate 3, whereby the non-uniform amount of the clay to be extruded in a stage where the clay has passed through the through-holes 6 of the first porous plate 3 can become uniform to supply the clay to the die 5. Therefore, the formed ceramic article in which portions have a uniform density and which does not have any defect such as deformation can be obtained. In consequence, in a case where the formed ceramic article is obtained by extrusion-forming using the jig for extrusion-forming according to the present invention, even in a state in which a part of the filtering mesh 2 is clogged with the coarse particles and foreign matter contained in the clay, high yield is obtained. Moreover, even in a case where the filtering mesh is clogged to a certain degree, the filtering mesh 2 does not have to be changed every time the mesh is clogged, and hence the change frequency of the filtering mesh 2 is decreased to improve productivity.

It is to be noted that in the present invention, it needs to be constituted that the arrangement of the through-holes 6 of the first porous plate 3 does not coincide with that of the through-holes 7 of the second porous plate 4. Here, “the arrangement of the through-holes 6 of the first porous plate 3 does not coincide with that of the through-holes 7 of the second porous plate 4” denotes a state in which the through-holes 6 of the first porous plate 3 do not completely overlap with the through-holes 7 of the second porous plate 4 or a state in which the through-holes of one of the porous plate do not include those of the other porous plate as viewed from the extruding direction of the clay.

In a case where such a state is not present, the clay easily passes through the through-holes 7 of the second porous plate 4 before the space 8 between the first porous plate 3 and the second porous plate 4 is substantially filled with the clay which has passed through the through-holes 6 of the first porous plate 3. Therefore, the partial deviation of the amount of the clay to be supplied to the die 5 cannot sufficiently be eliminated.

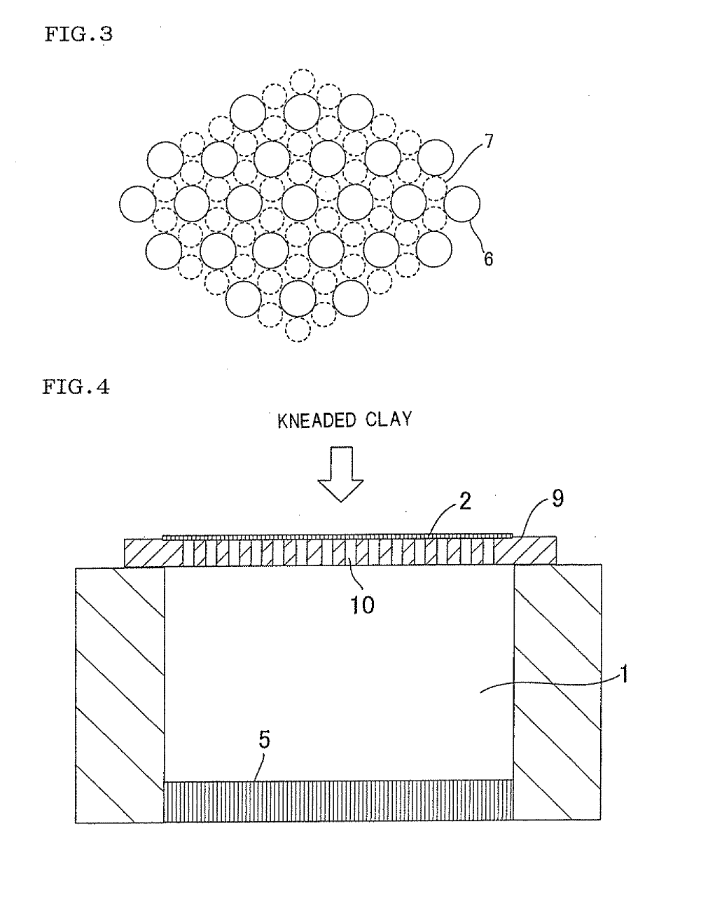

FIG. 2 is an explanatory view showing one example of an arrangement relation between the through-holes of the first porous plate and the through-holes of the second porous plate. The through-holes 6 of the first porous plate 3 may partially overlap with the through-holes 7 of the second porous plate 4 as viewed from the extruding direction of the clay, but the arrangement of the through-holes of both the plates is preferably adjusted so that the areas of overlapping portions can be minimized as shown in this drawing. FIG. 3 is an explanatory view showing another example of the arrangement relation between the through-holes 6 of the first porous plate 3 and the through-holes 7 of the second porous plate 4. Thus, the through-holes of both the plates are further preferably arranged so that the through-holes 6 of the first porous plate 3 do not overlap with the through-holes 7 of the second porous plate 4 at all.

There is not any special restriction on the hole diameters and arrangement pitches of the through-holes in the first and second porous plates, but it is preferable that the hole diameters are about 3 to 6 mm and that the arrangement pitches are about 3 to 8 mm. It is to be noted that the hole diameters, arrangement pitches, shapes and the like of the through-holes of the first and second porous plates may be different from each other or equal to each other. There is not any special restriction on the material and thickness of the first and second porous plates as long as the plates are not deformed or damaged under pressure when the clay passes. For example, a plate having a thickness of about 15 to 25 mm, made of stainless steel or carbon steel for a machine tool and provided with through-holes can preferably be used.

The filtering mesh has such openings that any coarse particle or foreign matter does not pass through the mesh. For example, a stainless steel mesh having opening is diameters of about 0.1 to 0.3 mm can preferably be used. The die can appropriately be selected in accordance with the shape of the formed ceramic article to be obtained, and, for example, in a case where the formed ceramic honeycomb article is formed, a die provided with slits formed in accordance with the dimensions of the through-holes and partition walls of the formed ceramic honeycomb article to be obtained may be used.

A space between the first porous plate 3 and the second porous plate 4 is preferably set to about 10 to 50 mm in respect of a clay-rectifying effect. Moreover, a space between the second porous plate 4 and the die 5 is preferably set to 80 mm or more from the viewpoint of the pressing of the clay extruded into a noodle-like shape.

In the jig for extrusion-forming according to the present invention, there is not any special restriction on the formed ceramic article as the forming target as long as the article has a shape which can be formed by the extrusion-forming. However, the jig can especially preferably be used in forming the formed ceramic honeycomb article having a honeycomb structure constituted of a thin wall portion which is easily deformed when the amount of the clay to be extruded deviates.

### EXAMPLES

The present invention will hereinafter be described in more detail in accordance with examples, but the present is invention is not limited to these examples.

### Example

Five hundred formed ceramic honeycomb articles (diameter: 200 mm, length: 200 mm, partition wall thickness: 130 μm, cell shape: quadrangle, cell densities: 64 cells/cm²) were extrusion-formed using a Dig for extrusion-forming according to the present invention having a structure shown in FIG. 1. Five parts by mass of methyl cellulose was added to 100 parts by mass of raw material particles treated with a 90 micron sieve, and they were kneaded using a kneader for 1.5 hours to be used as a clay. As a filtering mesh 2, a stainless steel mesh having opening diameters of 105 μm was used. As a first porous plate 3, a stainless steel plate having a thickness of 30 mm was used in which circular through-holes 6 having hole diameters of 6 mm were made at arrangement pitches of 8 mm, and as a second porous plate 4, a stainless steel plate having a thickness of 20 mm was used in which circular through-holes 7 having hole diameters of 6 mm were made at arrangement pitches of 8 mm, so that the through-holes 6 of the first porous plate 3 and the through-holes 7 of the second porous plate 4 had a positional relation shown in FIG. 2. As a die 5, a die provided with slits corresponding to the partition wall thicknesses, cell shapes and cell densities of the formed ceramic honeycomb article was used. A space between the first porous plate 3 and the second porous plate 4 was set to 30 mm, and a space between the second porous plate 4 and the die 5 was set to 200 mm. The presence of the deformation of the resultant 500 formed ceramic honeycomb articles was checked, and the articles which were not deformed (in the end face of each formed ceramic honeycomb article, the number of deformed cells was less than 5% of the total number of the cells) were regarded as acceptable articles to obtain a yield. The results are shown in Table 1.

### Comparative Example

Five hundred formed ceramic honeycomb articles having the same dimensions and structures as those of the above example were extrusion-formed using a conventional jig for extrusion-forming having a structure shown in FIG. 4. The clay, filtering mesh 2 and die 5 similar to those of the above example were used. As a porous plate 9, a plate similar to the first porous plate 3 of the above example was used. A space between the porous plate 9 and the die 5 was set to 230 mm. The presence of the deformation of the resultant 500 formed ceramic honeycomb articles was checked, and the articles which were not deformed were regarded as acceptable articles to obtain a yield. The result is shown in Table 1.

TABLE 1

| | No. of formed | No. of acceptable | Yield |
|---|---|---|---|
| | articles | articles | (%) |
| Example | 500 | 472 | 94 |
| Comparative | 500 | 328 | 66 |
| example | | | |

As shown in Table 1, in the example in which the jig for extrusion-forming according to the present invention was used, the formed articles were not easily deformed, and a high yield was obtained as compared with the comparative example in which the conventional jig for extrusion-forming was used.

### INDUSTRIAL APPLICABILITY

A jig for extrusion-forming according to the present invention can preferably be used in obtaining a formed ceramic article which can be formed by extrusion-forming, for example, formed ceramic honeycomb article for use in an application such as a catalyst carrier or a filter.

1. A jig for extrusion-forming which is used to obtain a formed ceramic article by extrusion-forming, comprising:
a cylindrical extrusion passage into which clay is fed;
a filtering mesh which is arranged so as to cover an inlet of the extrusion passage and which removes coarse particles and foreign matter from the clay;
a first porous plate which is brought into contact with the filtering mesh and provided with a plurality of through-holes;
a second porous plate arranged so as to leave a space from the first porous plate in the extrusion passage and provided with a plurality of through-holes; and
a die arranged so as to leave a space from the second porous plate in the extrusion passage,
wherein the arrangement of the through-holes of the first porous plate does not coincide with the arrangement of the through-holes of the second porous plate in the extruding direction of the clay.

2. The jig for extrusion-forming according to claim 1, wherein the formed ceramic article is a formed ceramic honeycomb article having a honeycomb structure.
